(19) United States
(12) Patent Application Publication
(10) Pub. No.: US 2013/0238561 A1
(43) Pub. Date: Sep. 12, 2013

(54) IMPORTANCE CLASS BASED DATA MANAGEMENT

(71) Applicant: Kalambur Subramaniam, Bangalore (IN)

(72) Inventor: Kalambur Subramaniam, Bangalore (IN)

(21) Appl. No.: 13/885,984

(22) PCT Filed: Jan. 27, 2011
(86) PCT No.: PCT/US11/22682

§ 371 Date: May 16, 2013

(51) Int. Cl. G06F 17/30

(52) U.S. Cl. CPC G06F 17/30221
USPC 707/647; 707/694

(57) ABSTRACT

A respective protection objective (38) that is associated with each of multiple data sets (36) stored on respective nodes (12-20) of a network (10) is ascertained. Each protection objective (38) defines a respective policy for managing the associated data set. The data sets (36) are partitioned into respective importance classes based on the associated protection objectives. A schedule for managing the data sets (36) is determined based on the protection objectives (38) and the respective importance classes (40) into which the data sets (36) are partitioned.

### BACKGROUND

Information Management encompasses a variety of different services and processes for collecting, organizing, processing, and delivering information. An important aspect of these services and tasks involves managing data, which includes back up, archiving, ensuring information accessibility, quick disaster recovery, and protecting against data loss. The complexity, cost, and resource utilization required to manage data increases as the volume and diversity of the data increase. In an effort to reduce costs, information management administrators constantly are striving to provide information services in the most efficient and cost-effective way that does not constrain other business functions by overloading network bandwidth and storage resources. Data archival and storage processes typically are inefficient users of network and data storage resources. These inefficiencies typically reduce disaster recovery performance and stress network resources.

### DESCRIPTION OF DRAWINGS

FIG. 1 is a block diagram of an example of a computer network.

FIG. 2 is a flow diagram of an example of a method of managing data.

FIG. 3 is a diagrammatic view showing examples of relationships between data sets, protection objectives, and importance classes.

FIG. 4 is a diagrammatic view of an example of information flow in a process or routing data sets to respective network nodes.

FIG. 5 is a flow diagram of an example of a method of managing data.

FIG. 6 is a block diagram of an example of a planning system.

FIG. 7 is a block diagram of an example of an information management system architecture.

FIG. 8 is a block diagram of an example of a computer system.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. DEFINITION OF TERMS

A “computer” is any machine, device, or apparatus that processes data according to computer-readable instructions that are stored on a computer-readable medium either temporarily or permanently. A “computer operating system” is a software component of a computer system that manages and coordinates the performance of tasks and the sharing of computing and hardware resources. A “software application” (also referred to as software, an application, computer software, a computer application, a program, and a computer program) is a set of instructions that a computer can interpret and execute to perform one or more specific tasks. A “data file” is a block of information that durably stores data for use by a software application.

The term “computer-readable medium” refers to any tangible, non-transitory medium capable storing information (e.g., instructions and data) that is readable by a machine (e.g., a computer). Storage devices suitable for tangibly embodying such information include, but are not limited to, all forms of physical, non-transitory computer-readable memory, including, for example, semiconductor memory devices, such as random access memory (RAM), EPROM, EEPROM, and Flash memory devices, magnetic disks such as internal hard disks and removable hard disks, magneto-optical disks, DVD-ROM/RAM, and CD-ROM/RAM.

A “network node” (also referred to simply as a “node”) is a junction or connection point in a communications network. Exemplary network nodes include, but are not limited to, a terminal, a computer, and an edge device. A “server” network node is a host computer on a network that responds to requests for information or service. A “client” network node is a computer on a network that requests information or service from a server. A “network connection” is a link between two communicating network nodes.

A “data set” is any logical grouping of information that is organized an categorized for a particular purpose. Examples of data sets include documents, numerical data, and other outputs that are produced by software application programs, sensors, and other electronic devices.

A “protection objective” is a specification of a policy for managing information.

As used herein, the term “includes” means includes but not limited to, the term “including” means including but not limited to. The term “based on” means based at least in part on.

The examples that are described herein provide systems and methods of managing data based on the relative importance of the data. For example, the relative importance of data may be used to optimize the utilization of resources and resolve resource usage conflicts involved in implementing data protection plans. In some of these examples, the relative importance of data is inferred from the protection objectives associated with the data. In this way, these examples provide an efficient approach for determining the relative importance of data in a way that avoids the necessity of having customers explicitly specify the relative importance of the data.

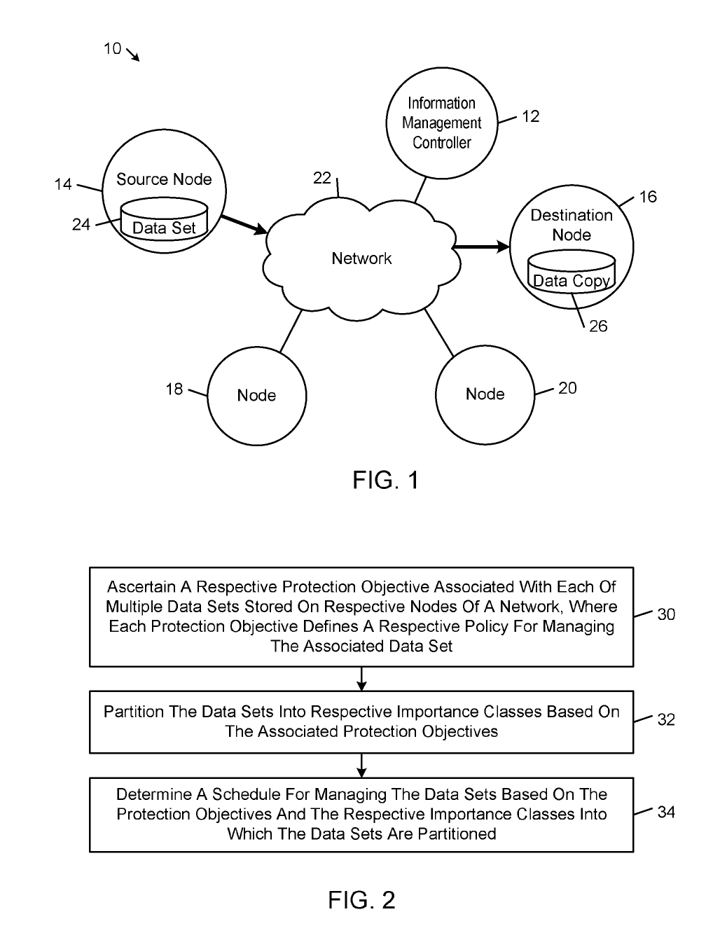

FIG. 1 shows an example of a network environment 10 that includes a network 22 that connects an information management controller 12 with a plurality of network nodes, including, a source network node 14, a destination network node 16, and other network nodes 18, 20. In operation, the information management controller 12 manages information generated by the nodes 14-20 by managing various data protection processes (e.g., data storage and archiving processes) that allow the information management controller 12 to control information access, provide disaster recovery, and protect against data loss. In one example of a data protection process, the information management controller 12 manages the copying of a data set 24 from the source node 14 to produce a data copy 26 on the destination node 16 (also referred to herein as a recipient node).

In some examples, the information management controller 12 includes a computer system (e.g., a server or a group of servers) that are configured with a computer program to perform a series of information management tasks. The information management controller 12 may be a centralized control system or a distributed system. The information management controller 12 typically is configured to store, archive, copy, and move data stored on or produced by the nodes 14-20. The nodes 14-40 may be servers, other computing devices, databases, storage areas, or other systems or devices that are configured to facilitate information management tasks performed with the information management controller 12. The network 22 may include any of a local area network (LAN), a metropolitan area network (MAN), and a wide area network (WAN) (e.g., the internet). The network 22 typically includes a number of different computing platforms and transport facilities that support the transmission of a wide variety of different media types (e.g., text, voice, audio, and video) between network nodes.

FIG. 2 shows an example of a data protection method that is performed by examples of the information management controller 12. In accordance with this method, the information management controller 12 ascertains a respective protection objective associated with each of multiple data sets stored on respective nodes of the network 22, where each protection objective defines a respective policy for managing the associated data set (FIG. 2, block 30). The information management controller 12 partitions the data sets into respective importance classes based on the associated protection objectives (FIG. 2, block 32). The information management controller 12 determines a schedule for managing the data based on the protection objectives and the respective importance classes into which the data sets are partitioned (FIG. block 34).

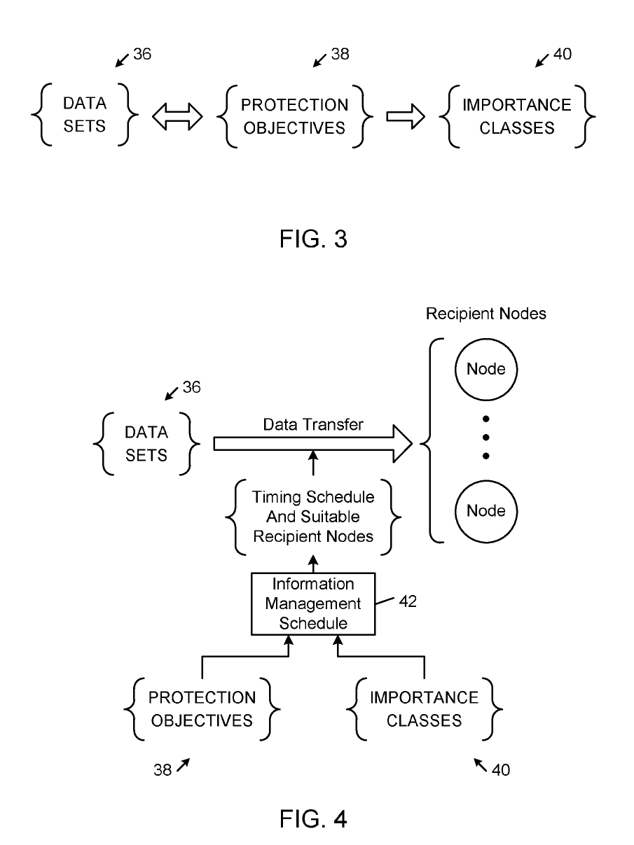

The information management controller 12 may ascertain the respective protection objective that is associated with each of multiple data sets stored on respective nodes of the network 22 in a variety of ways (see FIG. 2, block 30). In some examples, the process ascertaining the protection objective involves ascertaining an association between a respective one of the specified protection objectives and a particular class of software applications associated with the data to be protected, or ascertaining an association between a respective one of the specified protection objectives and a particular data class corresponding to the data to be protected. In the example shown in FIG. 3, each data set 36 to be protected is associated with a respective protection objective 38 (referred to herein as a Protection Service Level Objective, or Protection SLO). These associations typically are specified by an administrator and stored in a data structure (e.g., a table). An administrator can configure a protection objective 38 for a class of applications that correspond with a function of a business entity. For example, the administrator can configure a respective one of the protection objectives 38 to cover a set of applications corresponding to relational databases in the finance department of a business entity. An administrator also can configure a respective one of the protection objectives 38 to cover a respective class of data, such as all documents that operate with a certain software application. For example, the administrator can configure a protection objective 38 that covers a set of presentation documents adapted to be run with the PowerPoint presentation application (available from Microsoft Corporation of Redmond, Wash., U.S.A.). Any newly discovered nodes, servers, or documents as well as existing nodes, servers and documents will be covered by respective ones of the protection objectives 38 if they match the classes specified in the respective protection objectives 38.

The information management controller 12 may partition the data sets into respective importance classes based on the associated protection objectives in a variety of different ways (see FIG. 2, block 32).

In some examples, for each of the data sets, the information management controller 12 derives a respective importance score based on the associated protection objectives 38, and assigns the data sets to respective importance classes 40 based on the respective importance scores. In an example described in greater detail below, the information management controller 12 determines a respective protection metric that characterizes the respective information management policy defined by the protection objective for each of the protection objectives 38, and determines the respective importance scores from the respective protection metrics. In some examples, each protection metric includes a parameter vector of parameter values characterizing different aspects of the respective information management policy. In some of these examples, each parameter vector characterizes a respective data movement type specified by the respective protection objective according to data copying speed associated with the respective data movement type, availability of data copied in accordance with the respective data movement type, and maximum data loss associated with the respective data movement type. In some examples, the respective importance score is determined as a function that increases with higher data copying speed associated with the respective data movement type, increases with higher availability of data copied in accordance with the respective data movement type, and decreases with higher maximum data loss associated with the respective data movement type.

In some examples, the information management controller 12 determines a respective importance class into which a particular data set is to be partitioned based on the protection objectives and the importance classes associated with previously partitioned data sets. For example, given a newly added oracle database server that needs to be protected, we can infer the importance class and the protection objectives of the newly configured oracle database by examining the respective attributes of other oracle database servers.

The information management controller 12 may determine a schedule for managing the data based on the protection objectives and the respective importance classes into which the data sets are partitioned in a variety of different ways (FIG. block 34). In some examples, this process involves determining a schedule for copying data from source ones of the nodes sourcing the data sets to recipient ones of the nodes storing copies of the data sets. In some of these examples, the information management controller 12 determines a respective set of the recipient nodes to receive the copy of the data set in accordance with the schedule for each data set.

In the example shown in FIG. 4, information management controller 12 determines an information management schedule 42 based on the protection objectives 38 and the importance classes 40. The schedule 42 specifies a time schedule for managing data (e.g., copying or archiving data), a recipient node pool schedule that describes a plurality of suitable recipient nodes that are available for use in managing the data during the time schedule in accordance with the protection objectives 38 and the importance classes 40.

In some examples, the information management controller 12 manages the routing of data copying from the source nodes to the recipient nodes in accordance with the schedule.

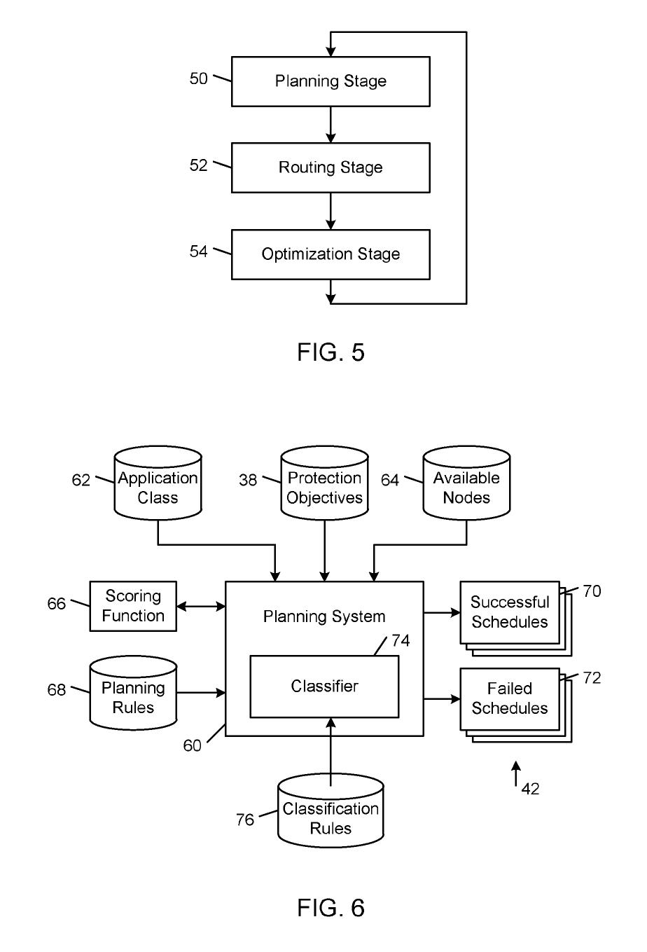

FIG. 5 shows an example of a data management method that is organized into three consecutive stages: a planning stage 50; a routing stage 52; and an optimization stage 54. In the planning stage 50, the information management controller 12 determines a schedule 42 for managing data (see FIG. 4). In the routing stage 52, the information management controller 12 executes the schedule 42. In this process, the information management controller 12 routes data from various source nodes to various destination nodes. In some examples (described below), the information management controller 12 generates a set of coordinating components that convey the data along network paths between the source nodes and the destination nodes. The initiation, application, and monitoring of the components is dynamic and performed with coordinating agents. In the optimization stage 54, the information management controller 12 analyzes process data that is generated during the planning stage 50 and the routing stage 52, along with network state data, and uses speculative rules to generate an optimized information management schedule for managing the data.

FIG. 6 is a block diagram of an example of a planning system 60, which is component of the information management controller 12 that automatically generates and monitors the execution of information management schedules that meet the Protection Service Level Objectives (SLOs) 38 that are set by the information management administrators to protect data. The planning system 60 receives as inputs at least one Protection SLO 38, a set of classes 62 that can be used with the Protection SLOs 38, a list 64 of available nodes, the output of a scoring function 66, and one or more sets of configurable planning rules 68 for at least one of the stages 50-54 of the process shown in FIG. 5. Some planning rules 68 are used by the planning system 60 in the planning stage 302 to calculate the scores of possible information management schedules. The planning rules 68 also may include speculative rules that may be used in the optimization stage 54.

When used in the planning stage 50 of the process shown in FIG. 5, the planning system 60 determines one or more information management schedules 42. In this process, for each information management schedule 42, the planning system 60 determines how often to copy the data to be protected and which pool of nodes 64 is available to store or archive the data copies. Among the factors that the planning system 60 uses in determining the information management schedules 42 are recovery preferences, backup window, application or application class, information specified in the Protection SLO, relative data importance information (discussed below), the availability of the devices in the device pool, and rules that either reflect constraints within the environment (e.g., network bandwidth), device capabilities (e.g., throughput), or rules that reflect common best practices applied by administrators (e.g., circumstance where a Storage Area Network is preferred over a local area network for connected devices). In some examples, the planning system 60 executes a rules based solver to optimize the information management schedules across all Protection SLOs in accordance in accordance with one or more of the planning rules 68. Examples of suitable rules-based solvers include a business rules management system (BRMS) (e.g., a Drools™ BRMS or a JBoss Rules™ reasoning engine based BRMS both of which are available from Red Hat, Inc. of Raleigh, N.C., U.S.A.).

In operation, the planning system 60 generates a set of one or more information management schedules and computes a respective feasibility score for each schedule based on the scoring function 66. In some examples, each score is calculated as a weighted average of the number constraints included in the scoring function 410. The schedules are marked as successful schedules 70 if they satisfy respective ones of the Protection SLOs and are marked as failed schedules 72 if they do not satisfy respective ones of the Protection SLOs. In the process of executing a successful information management schedule 70, the planning system 60 typically dynamically resolves the order of application backups to be performed as well as the devices or sets of devices to be used for the data protection. In some examples, the information management schedules are configured with a set of rules for selecting available devices based on a variety of factors, including availability, network bandwidth, and maintenance minimization.

In the process of generating the information management schedules 42, the planning system 60 module takes into account the relative importance of the data being protected. In this way, information management administrators are able to automate the resolution of resource conflicts by favoring the more important data over the lesser important data.

In the example illustrated in FIG. 6, the planning system 60 includes a classifier 74 that attempts to automatically classify the data to be protected based on the data management policies (e.g., data protection and archiving policies) that are defined in protection objectives 38 that are associated with the data. In this way, the classifier infers the relative importance of various items of data from the protection objectives 38 that are used by the information management administrators in setting up data management policies in their organization. For example, if an information management administrator has set up disaster recovery for some data based on replication built into disk arrays, it can be inferred that the speed of making a copy is important and also important is the reliability of the copy. In these examples, the classifier 74 derives parameter values from the protection objectives 38 and uses an inference engine that operates on the parameter values to determine the relative importance of the associated data in accordance with a set of user configurable classification rules 76.

In some examples, the classifier 74 determines values of the following parameters for each protection objective:
Speed of Copy
Availability of Copy
Max_Data_Loss
   The values of these parameters are computed, using an inference engine for each data protection configuration by associating a tuple <speed, availability, max_data_loss> with each data movement type (i.e., the type of technology used to achieve the data copy from the data source on the production system to a backup system). The value of the Speed of Copy parameter depends on the device type selected for making a copy. For example, using a storage array technology will be faster than using a virtual tape library (VTL). An information management administrator is able to specify the speed of copy parameter value associated with different types of device targets configured for backup. The value of the Availability of Copy depends on the number of copies and how easily these are available for restore. For example, data stored on tapes takes longer to restore or multiple incremental backups takes longer to restore. The value of the Max_Data_Joss parameter is governed by the frequency of backups. Higher values are better for the Speed Copy and the Availability of Copy parameters, whereas lower values are better for the Max_Data_Loss parameter.

Using an inference engine with configurable weights for computation of the Speed of Copy, Availability of Copy, and Max_Data_Joss parameters, permits easy customization on a per administrator need. Each of the above mentioned parameters and the rules to compute them on different aspects of the protection objective specifications are stored in the classification rules 76.

After computing the Speed of Copy, Availability of Copy, and Max_Data_Loss parameters for all the data sources, the classifier 74 normalizes the computed values across the sources. In some examples, the Max_Data_Loss parameter values are normalized to a value between zero (0) and one (1). In some examples, a respective importance score (Importance) is determined for each of the data sets by evaluating equation (1):

Importance=(speed of copy+availability of copy)*(1−Max_Data_Loss) (1)

The Importance scores assigned to the data sets can then be used for determining if the resources are being utilized optimally across the network.

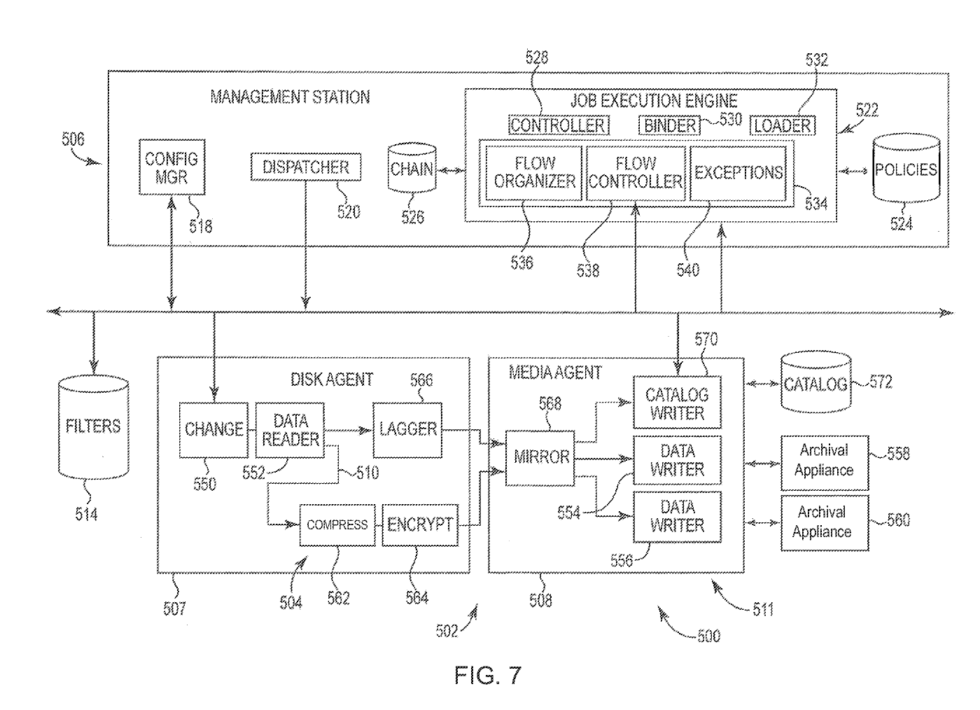

FIG. 7 shows an example of a unified information management system architecture 500 suitable for performing the routing stage 52 of the data protection process shown in FIG. 5 and for executing the successful information management schedules 70. The information management system architecture 500 includes a filter chain 502 that has a set of connected-together components 504 that perform a coordinated data transfer. The information management system architecture 500 also includes a management station 506 that builds and controls the filter chain 502. The management station 506 may be a server (or servers) on which the management components reside and may operate to serve clients (referred to herein as “IM clients”) on the network 22.

The connected-together components 504 perform the data routing stage 52 (FIG. 5). These components 504 are generic and can be dynamically coupled together to execute an information management schedule. In the illustrated example, the filter chain 502 includes a disk agent 507 and a media agent 508, both of which are controlled by the management station 506. Data flows from component to component along arrows 510. The connected-together components 504 form a unified information management bus 511 for routing data. Components can be selected from a group of existing filters stored in a filter library 514.

The management station 506 includes a configuration manager 518 that deploys the components 504 of the filter chain 502 to the various IM clients on the network 22. The management station 506 also includes a dispatcher 520 that is used to execute a job from a selected information management schedule. In one example, the dispatcher 520 can prioritize jobs from several received or pending information management schedules. In one example, the dispatcher 520 interfaces with and receives information management schedules from the planning system 60. The management station 506 also includes a job execution engine 522.

The job execution engine 522 creates and monitors the filter chain 502. The job execution engine 522 interfaces with a policies repository 524 and with a state of chain repository 526. The policies repository 524 contains blueprints of the filter chains 502 and the planning rules 68, which include policy type planning rules that can be used within the routing stage 52 (FIG. 5). The policy type planning rules can be evaluated by a rules-based system, which can be separate from the rules-based planner described above, in order to determine if the policies are fulfilled or violated. The job execution engine 522 also includes a controller 528, a binder 530, and loader 532 that are used to perform the respective features of the engine 522. The job execution engine 522 also includes a flow manager 534 to execute the information management schedule.

The flow manager 534 includes a flow organizer 536, a flow controller 538, and an exception handler 540. The flow organizer 536 uses a blue print of a filter chain for a given operation, creates an instance of the filter chain from the blue print, and assigns various resources to execute the filter chain in an optimal manner. The flow controller 538 is used to execute the instance of the filter chain created with the flow organizer 536. The flow controller 538 will set up the bus and all the components 504 along the bus. As a component completes all the tasks allocated to it, the flow controller 538 is responsible for starting other components, assign new tasks or deleting old components in the filter chain 502. The exception handler 540 resolves events on the components that will employ centralized management.

The job execution engine 522 receives the information management schedule from the planning system 60 and adds further details such as the name of an agent and the client on which that agent is started. The type of job to be executed is used to arrive at the name of the agent. For example, a backup type job includes a change control filter 550 coupled to a data reader 552, which are started at the source client. The factors that govern clients of the data writer filters 554, 556, for example, depends on the accessibility of the destination device, or node, to the source client and other factors considered in the information management schedule developed with the planning system 60. In the case of an information management schedule requesting an archival copy, a suitable archival appliance 558, 560, for example, is chosen from node pool. The job execution engine 522 also sets up the intermediate filters in the data transformation on one or more hosts on the network 22, which could be hosts other than those used for the source or destination (i.e., hosts other than used for the data reader 552 and the data writers 554, 556 and are selected based on performance considerations). The data reader 552 can be connected to a compression filter 562 encryption filter 564, which compresses and encrypts the data including the metadata. The data reader filter 552 is also coupled to a logger filter 566, in the example. The logger and encryption filters 566, 564, form the disk agent 506 are couple to a mirror filter 568 of the media agent 508. In addition to being coupled to the data writers 554, 556, the mirror 568 is also coupled to a catalog writer filter 570 which can then write to a catalog 572 on the network 22.

Examples of the information management controller 12 may be implemented by one or more discrete modules (or data processing components) that are not limited to any particular hardware, or machine readable instructions (e.g., firmware or software) configuration. In the illustrated examples, these modules may be implemented in any computing or data processing environment, including in digital electronic circuitry (e.g., an application-specific integrated circuit, such as a digital signal processor (DSP)) or in computer hardware, device driver, or machine readable instructions (including firmware or software). In some examples, the functionalities of the modules are combined into a single data processing component. In some examples, the respective functionalities of each of one or more of the modules are performed by a respective set of multiple data processing components.

The modules of the information management controller 12 may be co-located on a single apparatus or they may be distributed across multiple apparatus; if distributed across multiple apparatus, these modules may communicate with each other over local wired or wireless connections, or they may communicate over global network connections (e.g., communications over the Internet).

In some implementations, process instructions (e.g., machine-readable code, such as computer software) for implementing the methods that are executed by the examples of the information management controller 12, as well as the data they generate, are stored in one or more machine-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

In general, examples of the information management controller 12 may be implemented in any one of a wide variety of electronic devices, including desktop computers, workstation computers, and server computers.

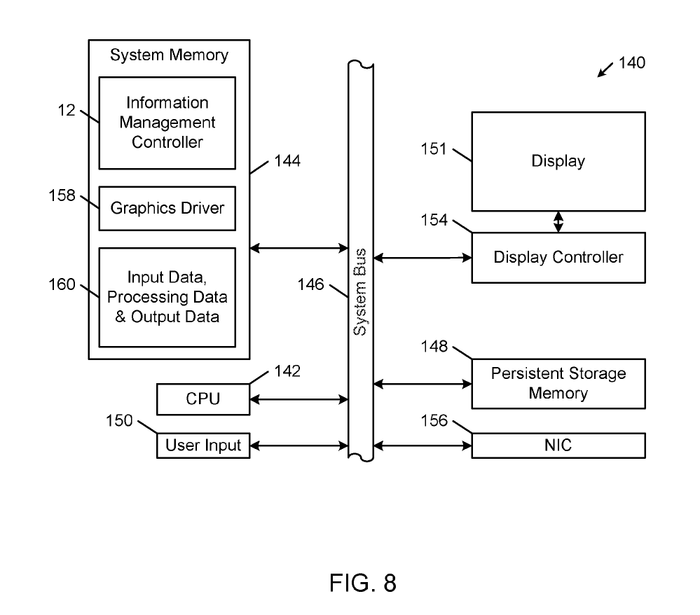

FIG. 8 shows an example of a computer system 140 that can implement any of the examples of the information management controller 12 that are described herein. The computer system 140 includes a processing unit 142 (CPU), a system memory 144, and a system bus 146 that couples processing unit 142 to the various components of the computer system 140. The processing unit 142 typically includes one or more processors, each of which may be in the form of any one of various commercially available processors. The system memory 144 typically includes a read only memory (ROM) that stores a basic input/output system (BIOS) that contains start-up routines for the computer system 140 and a random access memory (RAM). The system bus 146 may be a memory bus, a peripheral bus or a local bus, and may be compatible with any of a variety of bus protocols, including PCI, VESA, Microchannel, ISA, and EISA. The computer system 140 also includes a persistent storage memory 148 (e.g., a hard drive, a floppy drive, a CD ROM drive, magnetic tape drives, flash memory devices, and digital video disks) that is connected to the system bus 146 and contains one or more computer-readable media disks that provide non-volatile or persistent storage for data, data structures and computer-executable instructions.

A user may interact (e.g., enter commands or data) with the computer 140 using one or more input devices 150 (e.g., a keyboard, a computer mouse, a microphone, joystick, and touch pad). Information may be presented through a user interface that is displayed to a user on the display 151 (implemented by, e.g., a display monitor), which is controlled by a display controller 154 (implemented by, e.g., a video graphics card). The computer system 140 also typically includes peripheral output devices, such as speakers and a printer. One or more remote computers may be connected to the computer system 140 through a network interface card (NIC) 156.

As shown in FIG. 8, the system memory 144 also stores the information management controller 12, a graphics driver 158, and processing information 160 that includes input data, processing data, and output data. In some examples, the information management controller 12 interfaces with the graphics driver 158 to present a user interface on the display 151 for managing and controlling the operation of the information management controller 12.

Other embodiments are within the scope of the claims.

1. A method, comprising:
ascertaining a respective protection objective (38) associated with each of multiple data sets (36) stored on respective nodes (12-20) of a network (10), wherein each protection objective (38) defines a respective policy for managing the associated data set;
partitioning the data sets (36) into respective importance classes (40) based on the associated protection objectives; and
determining a schedule for managing the data sets (36) based on the protection objectives (38) and the respective importance classes (40) into which the data sets (36) are partitioned;
wherein the ascertaining, the partitioning, and the determining are performed by a computer system.

2. The method of claim 1, wherein the ascertaining comprises ascertaining an association between a respective one of the protection objectives (38) and a particular class of software applications, and ascertaining an association between a respective one of the protection objectives (38) and a particular class of data.

3. The method of claim 1, wherein the partitioning comprises deriving a respective importance score for each of the data sets (36) based on the associated protection objectives, and assigning the data sets (36) to the respective importance classes (40) based on the respective importance scores.

4. The method of claim 3, wherein the deriving comprises:
for each of the protection objectives, determining a respective protection metric characterizing the respective information management policy defined by the protection objective; and
determining the respective importance scores from the respective protection metrics.

5. The method of claim 4, wherein each protection metric comprises a parameter vector of parameter values characterizing different aspects of the respective information management policy.

6. The method of claim 5, wherein each parameter vector characterizes a respective data movement type specified by the respective protection objective (38) according to data copying speed associated with the respective data movement type, availability of data copied in accordance with the respective data movement type, and maximum data loss associated with the respective data movement type.

7. The method of claim 6, wherein the deriving comprises, for each of the data sets, determining the respective importance score as a function that increases with higher data copying speed associated with the respective data movement type, increases with higher availability of data copied in accordance with the respective data movement type, and decreases with higher maximum data loss associated with the respective data movement type.

8. The method of claim 1, wherein the portioning comprises determining a respective importance class (40) into which a particular data set (36) is to be partitioned based on the protection objectives (38) and the importance classes (40) associated with previously partitioned data sets.

9. The method of claim 1, wherein the determining comprises determining a schedule for copying data from source ones of the nodes (12-20) sourcing the data sets (36) to recipient ones of the nodes (12-20) storing copies of the data sets.

10. The method of claim 9, wherein the determining comprises, for each data set, determining a respective set of the recipient nodes (12-20) to receive the copy of the data set (36) in accordance with the schedule.

11. The method of claim 9, wherein the determining comprises managing the routing of data copying from the source nodes (12-20) to the recipient nodes (12-20) in accordance with the schedule.

12. Apparatus (140), comprising:
a memory (144, 148) storing processor-readable instructions; and
a processor (142) coupled to the memory, operable to execute the instructions, and based at least in part on the execution of the instructions operable to perform operations comprising
ascertaining a respective protection objective (38) associated with each of multiple data sets (36) stored on respective nodes (12-20) of a network (10), wherein each protection objective (38) defines a respective policy for managing the associated data set;
partitioning the data sets (36) into respective importance classes (40) based on the associated protection objectives; and
determining a schedule for managing the data sets (36) based on the protection objectives (38) and the respective importance classes (40) into which the data sets (36) are partitioned.

13. The apparatus of claim 12, wherein the partitioning comprises deriving a respective importance score for each of the data sets (36) based on the associated protection objectives, and assigning the data sets (36) to the respective importance classes (40) based on the respective importance scores.

14. The apparatus of claim 13, wherein the deriving comprises:
for each of the protection objectives, determining a respective protection metric characterizing the respective information management policy defined by the protection objective; and
determining the respective importance scores from the respective protection metrics.

15. At least one computer-readable medium (144, 148) having processor-readable program code embodied therein, the processor-readable program code adapted to be executed by a processor (142) to implement a method comprising:
ascertaining a respective protection objective (38) associated with each of multiple data sets (36) stored on respective nodes (12-20) of a network (10), wherein each protection objective (38) defines a respective policy for managing the associated data set;
partitioning the data sets (36) into respective importance classes (40) based on the associated protection objectives;
determining a schedule for managing the data sets (36) based on the protection objectives (38) and the respective importance classes (40) into which the data sets (36) are partitioned.
